(19) United States
(12) Patent Application Publication
(10) Pub. No.: US 2007/0073936 A1
(43) Pub. Date: Mar. 29, 2007

(54) Dynamic physical interface between computer module and computer accessory and methods

(75) Inventors: Ivan R. Cardenas, Sugarland, TX (US); Frank van Weerdenberg, Den Dungen (NL)

Correspondence Address: KLARQUIST SPARKMAN, LLP, 121 SW SALMON STREET, SUITE 1600, PORTLAND, OR, 97204, US

(73) Assignee: Ivan R. Cardenas

(21) Appl. No.: 11/454,119

(22) Filed: Jun. 14, 2006

Related U.S. Application Data
(63) Continuation of application No. PCT/US05/30432, filed on Aug. 26, 2005.
(60) Provisional application No. 60/605,188, filed on Aug. 27, 2004.

(51) Int. Cl. G06F 13/38; G06F 13/12

(52) U.S. Cl. 710/62

(57) ABSTRACT

Embodiments of a dynamic connecting element interface between a computer module and a computer accessory for a modular computer system are described herein. According to one exemplary embodiment, a computer system includes a computer accessory, a modular computing module having a core processor and a memory and a connector configured to detachably and electrically connect the computer accessory and the modular computing module. The connector can have a plurality of connecting elements configured to support communication between the modular computing module and the computer accessory. At least one of the plurality of connecting elements comprises a dynamic connecting element that is capable of supporting multiple computing functions.

### CROSS REFERENCE TO RELATED APPLICATIONS

This is a continuation of International Application No. PCT/2005/030432, filed Aug. 26, 2005, which was published in English under PCT Article 21(2), which in turn claims the benefit of U.S. Provisional Application 60/605,188, filed Aug. 27, 2004. These applications are incorporated herein by reference.

### FIELD

This application concerns computer processing systems, such as modular computing systems which include a cartridge-based design for portable and fixed computers, and in particular, a physical interface between a computer module (modular computer) and an accessory or companion device.

### BACKGROUND

Known computer systems can be segmented generally into two distinct categories: portable and fixed. Portable computer processing systems are designed to be portable between different work sites (i.e. office, home and travel) and may be characterized, for example, as laptop computer systems, notebook computer systems, sub-notebook computer systems, tablet computer systems and hand held computer systems, such as Personal Digital Assistants (PDAs). On the other hand, fixed computer processing systems are intended to remain stationary at a single work site and may be characterized, for example, as desktop computer processing systems and tower computer processing systems.

Portable computer systems include components functionally equivalent to those of the larger fixed computer systems, yet the components of the portable computer processing system are designed and packaged in accordance with restricted dimensional and weight specifications required for portability. Such components often include, for example, a microprocessor, associated memory, a lightweight and compact keyboard and display, and PCMCIA standard devices such as fax-modems, wired local area network adapters, wireless local area network interface modules, digital data exchange adapters and hard disk drives. Yet, because of the dimensional and weight restrictions associated with the components of the portable computer processing system, the associated costs of the portable computer processing system are much greater than the costs of comparable fixed computer processing systems, and these additional costs are reflected in the purchase price of portable computer processing systems.

Moreover, a user may require two or more computer systems in separate applications/work modes. For example, a user may require a fixed desktop computer system for work and a portable laptop computer system for travel and home-use. In this case, the user is required to expend a significant investment in purchasing the separate computer systems, which may limit the market for both the fixed and portable computer processing systems.

Because of these limiting cost factors, there is a long standing need in the field of computer processing systems to provide efficient and flexible computer processing systems while achieving low costs.

It is also desirable to provide the functionality of connecting various peripheral devices internal to the chassis of a computer processing system, such as a PCMCIA fax-modem, to an associated peripheral device external to the chassis of the computer processing system, such as a telephone line linked to a telephone network. Typically, various internal peripheral devices are uniquely connected to their associated external peripheral device. For example, an internal PCMCIA fax-modem may be designed to extend out through a slot in the chassis and include a unique connector at its exposed end to mate with a telephone line. However, such unique connectors among the various peripheral devices create inconvenience and lost efficiency in portable computer processing systems, because a user must first disconnect the peripheral devices to move the computer processing system from, for example, a home environment to a work environment, and then reconnect the peripherals upon return, which causes undue delay and frustration.

To alleviate these concerns, some known systems included a computer module or cartridge that is selectively mated with any one of a number of associated computer base units or computer accessories, which include computer chassis types and computer shell types. For example, one base unit may be a fixed PC desk computer chassis having a first set of user interfaces such as a keyboard, a mouse, a display, a microphone, a data storage device or various other input/output devices. Another base unit may be a fixed device or a portable device such as a laptop, notebook computer or sub-notebook computer chassis, a tablet computer system chassis, or a hand held computer system chassis or PDA.

Some computing cartridges include a core processor, a memory, a hard disk unit and a system controller. Moreover, computing cartridges can include a physical interface which engages an interface of a compatible computer accessory. The computing cartridge and the accessories can each include a bus for interconnecting the various components of the computing cartridge and accessories, respectively.

In some computing cartridges, the physical interface is achieved by an electrical connection using a multi-pin connector. Certain pins define the connection for a bus of the cartridge and a bus of each accessory that the cartridge is designed to be compatible with. Other pins connect the power bus of the cartridge to the power bus of a compatible accessory.

A limitation of known modular computing systems is that the configuration of the interface between the module and an accessory cannot be reconfigured. Each individual connection of the interface, e.g., the pins of the multi-pin connectors, between the common buses of the computing cartridge and a chassis to which it may be connected are associated with predefined functions. For example, an individual pin connection of the multiple pins of known connectors is predefined for a single function, such as to connect USB circuits, or audio, or Ethernet, etc. Consequently, any modular computer or accessory associated with the redesigned or upgraded accessory or modular computer, respectively, would also require a hardware upgrade, e.g., complete replacement by a separate upgraded compatible unit, to maintain interoperability.

Another limitation with known modular computing systems where the configuration of the interface between the module and an accessory is reconfigurable is that reconfiguration of the function specification definition can be implemented only by a simple unintelligent switch or digital setting communicated from the accessory to the host. For example, a hardwired set of connector pin energization states can represent a sequence of digital numbers that represent a certain pin configuration of the connector in a given application. Accordingly, once in place, the function specification definition is unalterable and adaptation to new function specification schemes, as might be required as the module and accessories evolve over time, cannot be achieved. Further, this limitation results in an inefficient method of providing detailed configuration information.

Because of these limitations, current systems cannot intelligently support the migration to rapidly evolving system architectures, for example, when the accessory or the modular computer is redesigned with a new set of features which were previously unanticipated.

Another limitation of known systems is their unsuitability for rugged, high-impact or high-mobility applications, such as, military, law enforcement, emergency medical response and heavy industry applications. More specifically, use of known computer systems in these applications, where the compactness and flexibility of a modular system to facilitate adaptability in response to rapidly changing environments and scenarios are desirable, would not be practical due to their inability to resist impact, corrosion and environmental contaminants.

### SUMMARY

Disclosed below are representative embodiments that are not intended to be limiting in any way. Instead, the present disclosure is directed toward novel and nonobvious features, aspects and equivalents of the embodiments of the dynamic interface between a computer module and an accessory described below. The disclosed features and aspects of the embodiments can be used alone or in various novel and nonobvious combinations and sub-combinations with one another.

As herein described, each individual connection of the dynamic interface between a computer module and an accessory can intelligently support more than one function over time without requiring hardware upgrades. Moreover, a dynamic interface can provide more advanced and efficient methods for providing detailed interface configuration information, which facilitates not only modifying function definitions in place, but also updating or modifying detailed pin function definitions, such as voltage levels and wave form characteristics, that may be required with different peripherals or accessories.

In other words, the dynamic interface between a computer module and an accessory having a bus architecture, such as an intelligent bus architecture, as described herein can increase the interoperability of computing modules and accessories over time to increase the return on investment in the equipment by providing at least the following advantages: (1) a single software license per user; (2) only one platform per user for an IT infrastructure to maintain resulting in fewer devices to inventory, reduction of custom programming for extraneous specialty devices, less training for users and less IT overhead; (3) increased capabilities for users resulting in enhanced productivity for organizations by offering full powered workstations in a highly compact design for mobile applications, minimizing synchronization issues among platforms, making sophisticated capabilities and features more economically feasible, sharing of peripheral devices among multiple users; and (4) strategic security for organizations by accommodating a sustainable and expandable infrastructure.

A dynamic interface between a computer module and an accessory can include an arrangement between a modular computing module and one or more accessories. The interface acts as a link by which stored function information for a connecting element in either the accessory or the computing module is transmitted to either the computing module or the accessory, respectively, to select a stored function so that a compatible connecting element between the computing module and the accessory is established.

The computer module can include many of the normal features of a conventional stationary or portable computer, for example, a processor, a hard drive, a memory, a video card, an audio card, a conventional operating system, etc. The module can be highly compact, and as such can be easily portable.

The computer module can be plugged into or connected to one or more computer accessories to activate or control applications or functions of the computer accessories.

The dynamic interface can increase the range of possible functions for a connecting element between the computing module and an accessory to compensate for changes, such as software, hardware or firmware upgrades, in the existing accessory or computing module, or replacement of the existing module or accessory with an updated module or accessory. In other words, the dynamic interface can preserve the usability of an accessory or computer module over long periods of time by maintaining compatibility of system components in the face of upgrades of an accessory and/or of the computing module.

In one embodiment, a computer system includes a computer accessory, a modular computing module having a core processor and a memory, and a connector configured to detachably and electrically connect the computer accessory and the modular computing module. The connector can have a plurality of connecting elements configured to support communication between the modular computing module and the computer accessory. At least one of the plurality of connecting elements can be capable of supporting multiple computing functions. In specific embodiments, the connector is a multi-pin connector and the connecting elements are pin.

In one embodiment, a data processing system comprises a computer accessory and a modular computing core. The modular computing core has a processor and a memory and is configured to detachably connect to the computer accessory. The system also includes structure for establishing a dynamic multiplexing interface between the computer accessory and the modular computing core. The interface can have multiple connecting elements and at least one of the connecting elements supports multiple computing functions.

In one embodiment, a dynamic interface between a modular computing module and a computer accessory comprises at least a first connecting element capable of supporting multiple computing functions. The dynamic interface also includes at least a second connecting element capable of supporting a function specification transmission or signal generated from a dedicated function specification memory in either the module or the computer accessory. The function of the multiple computing functions that is to be supported by the first connecting element is specified by the information transmission. In one specific implementation, the dynamic interface includes the 160 connection elements as designated in FIGS. 7a, 7b, 7c, 7d, with the first connecting element and the second connecting element being two of the 160 connecting elements.

In one embodiment, a method of interfacing a modular computer module and a computer accessory comprises detachably connecting a modular computer module having a core processor and a memory with a computer accessory via a connector having a plurality of connecting elements. At least a first connecting element is capable of supporting multiple computing functions. The method further comprises transmitting a first stored function specification signal from a memory in the module to a function enablement logic element in the accessory or from a memory in the accessory to a function enablement logic element in the module via a second connecting element. The first stored function specification signal specifies a first desired function to be supported by the first connecting element. The method comprises sending a signal from the enablement logic element in the accessory to activate a first of multiple function enablement circuits in the accessory or from the enablement logic in the module to activate a first of multiple function enablement circuits in the module. The first of the multiple function enablement circuits are coupled to the first connecting element and correspond to the first desired function. The method also includes supporting the first desired function via the first connecting element.

In one implementation, the modular computing module can comprise a first modular computing module and the computer accessory can comprise a first computer accessory. The method can further comprise disconnecting the first computer accessory from the first modular computing module and detachably connecting a second computer accessory to the first modular computing module via the connector.

In this implementation, the method can also include transmitting a second stored function specification signal from the memory in the first module to a function enablement logic in the second accessory or from a memory in the second accessory to the function enablement logic in the first module via the second connecting element. The second stored function specification signal specifies a second desired function to be supported by the first connecting element.

The method can also include sending a signal from the enablement logic of the second accessory to activate a second of multiple function enablement circuits in the second accessory or from the enablement logic of the first module to activate a second of multiple function enablement circuits in the first module. The second of multiple function enablement circuits correspond to the second desired function and one of the first multiple function enablement circuits is caused to be deactivated. The method further includes supporting the second desired function via the first connecting element.

In another embodiment, a method of interfacing a modular computer module and a computer accessory comprises detachably connecting a modular computer module having a core processor and a memory with a computer accessory via a connector having a plurality of connecting elements. The connector has at least one connecting element that is capable of supporting a first function, a second function and a third function. The method also includes the acts of (1) transmitting a first stored function specification signal specifying the first function to be supported by the connecting element; (2) activating a first function enablement circuit coupled to the connecting element to allow it to support the first function; (3) transmitting a second stored function specification signal specifying the second function to be supported by the connecting element; (4) deactivating the first function enablement circuit; (5) activating a second function enablement circuit coupled to the connecting element to allow it to support the second function; (6) transmitting a third stored function specification signal specifying the third function to be supported by the connecting element; (7) deactivating the second function enablement circuit; and (8) activating a third function enablement circuit coupled to the connecting element to allow it to support the third function.

The foregoing and other features and advantages will become more apparent from the following detailed description, which proceeds with reference to the accompanying figures.

### BRIEF DESCRIPTION OF THE DRAWINGS

FIG. 1 illustrates a computing module connected to a desktop computer accessory by way of a docking station.

FIG. 2a illustrates the computing module of FIG. 1 connected to a handheld accessory.

FIG. 2b illustrates the computing module of FIG. 1 connected to a wearable computer.

FIG. 2c illustrates the computing module of FIG. 1 connected to a laptop computer.

FIG. 3a is a perspective view of the computing module showing a module portion of a pin connector to connect to an accessory such as the desktop computer accessory of FIG. 1 or the handheld accessory of FIG. 2.

FIG. 3b is a frontal view of the module portion of the pin connector shown in FIG. 3a.

FIG. 4 is a schematic illustrating a first arrangement in which a connecting element can have multiple (e.g., three) functions, the connecting element connecting an accessory (shown at right) to a computing module (shown at left), where the accessory requires a second function F2 to be supported by the connecting element and transmits information about the function requirement for the connecting element to the module to select that function for the connecting element in the module.

FIG. 5 illustrates a second arrangement in which a connecting element can have multiple (e.g. three) functions, the connecting element connecting a computer module (shown at right) to an accessory (shown at left), where the module requires a second function F2 to be supported by the connecting element and transmits information about the function requirement for the connecting element to the accessory to select that function for the connecting element in the accessory.

FIG. 6 is a table showing an example of functions supported by specific connecting elements for several computer system configurations.

FIGS. 7a-7d are charts showing the interface specifications of several embodiments of a 160-pin connector according to the present disclosure.

### DETAILED DESCRIPTION

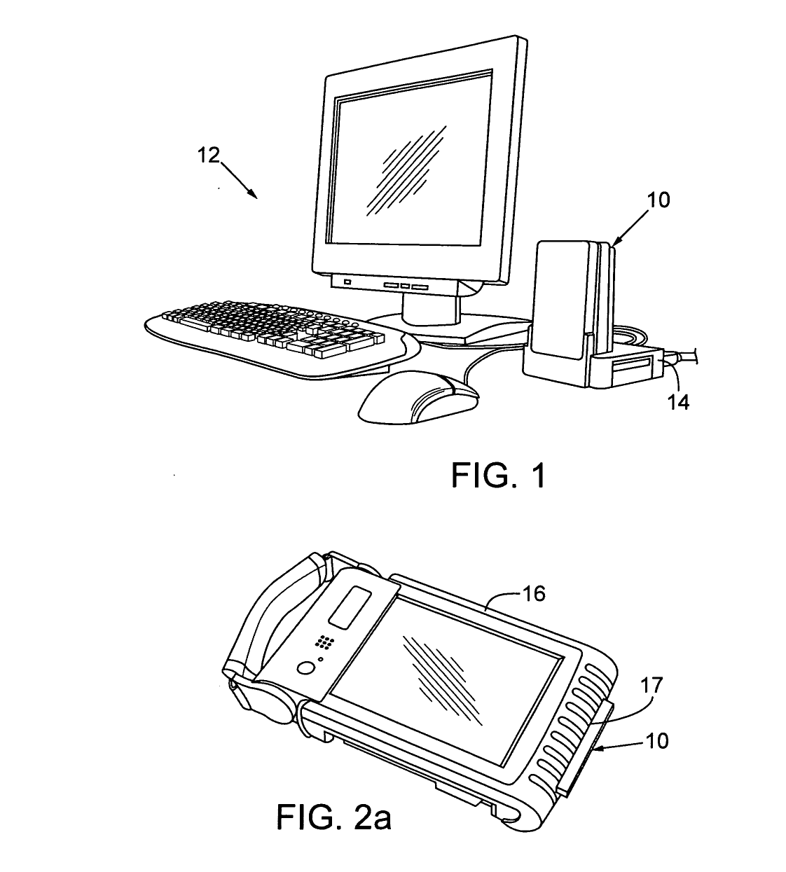

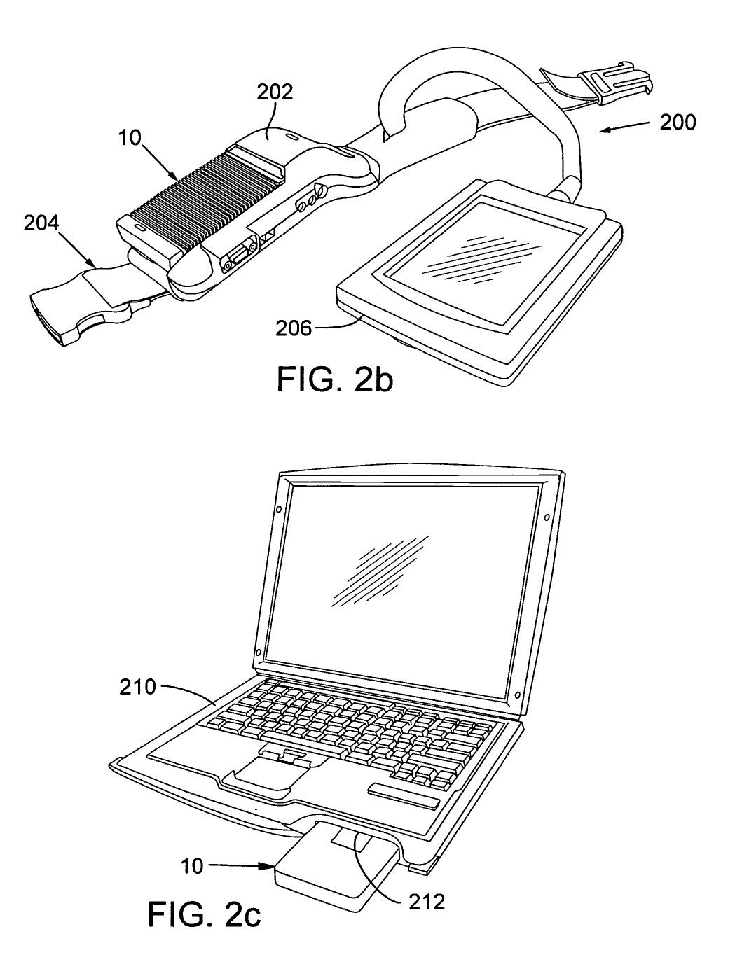

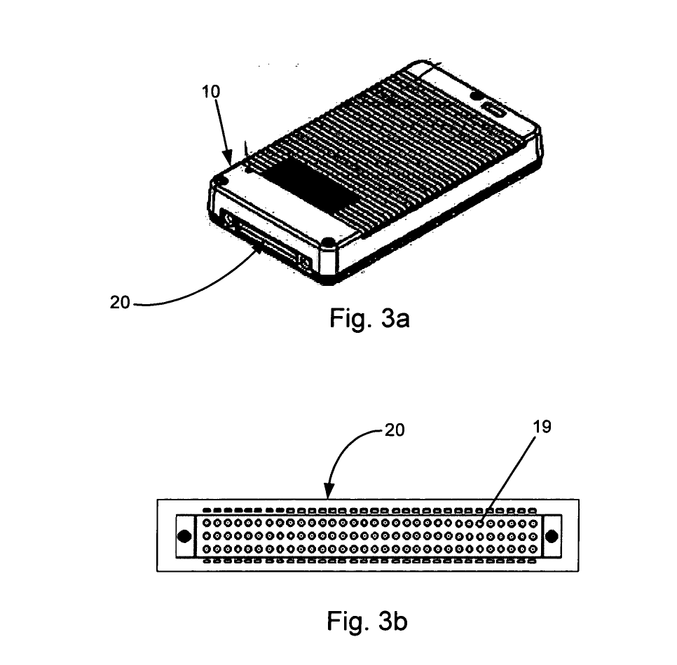

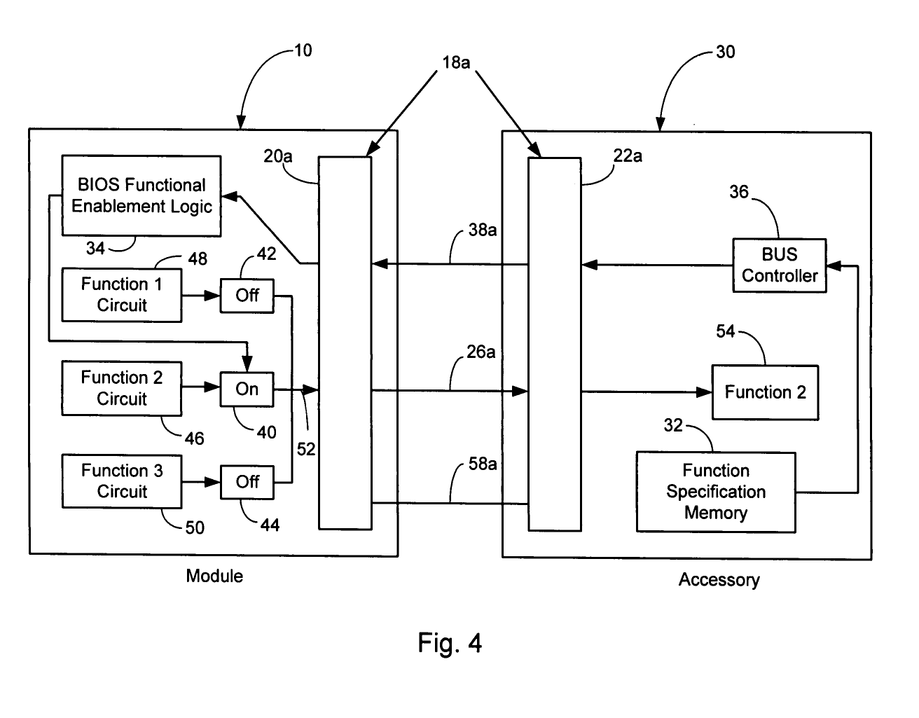

FIGS. 1 and 2 illustrate a computing module 10 being connected to two different accessories, respectively. In FIG. 1, a desktop computer accessory 12 is linked, or connected, to the computing module 10 by a docking station 14. As shown in FIG. 1, the desktop computer accessory 12 can include a display and an input device, such as a keyboard. Of course, the desktop computer accessory could include other elements.

Other accessories, which are sometimes referred to herein as chassis or shells, may be used separately or in combination with the computing module 10. Examples include a laptop computer chassis and a multiple function machine chassis similar to a fixed PC desk computer chassis but designed for embedded applications such as automation, kiosks, and non-administrative applications and also for machines which are portable, such as a tablet computer.

In one exemplary embodiment shown in FIG. 2a, the computing module 10 is connected to a handheld accessory 16 by inserting the module into a docking port 17 formed in the handheld accessory.

In another exemplary embodiment shown in FIG. 2b, the computing module 10 is connected to a wearable computer 200 by inserting the module into a docking station 202 attached to a belt 204 and electrically coupled to a handheld display 206. In some implementations, the handheld display 206 can include a touch and daylight readable screen.

In another exemplary embodiment shown in FIG. 2c, the computing module 10 is connected to a laptop computer 210 by inserting the module into a docking port 212 formed in the laptop computer.

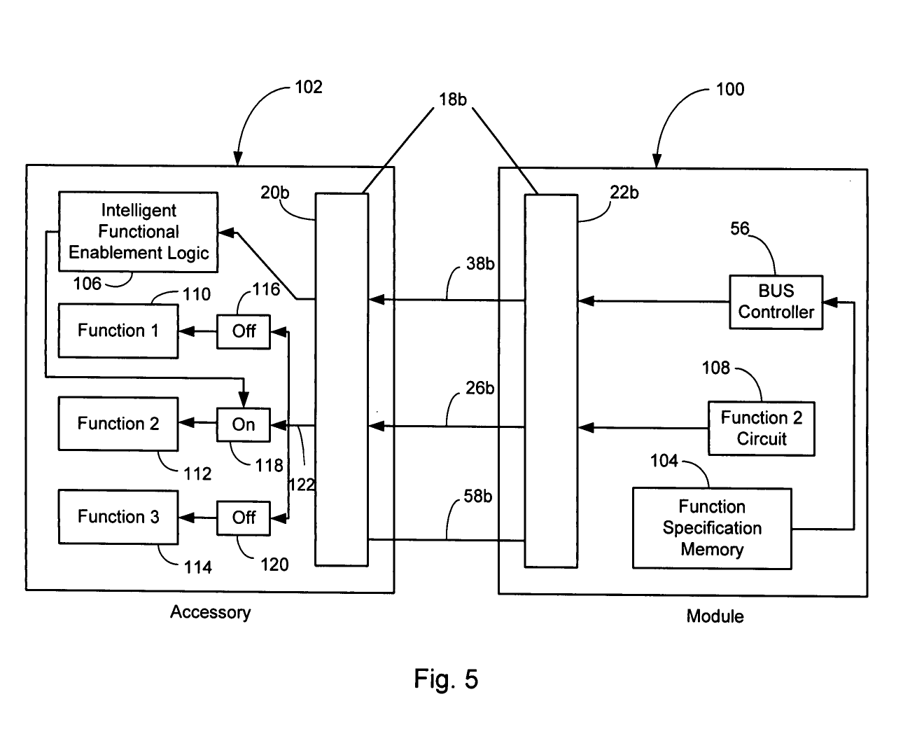

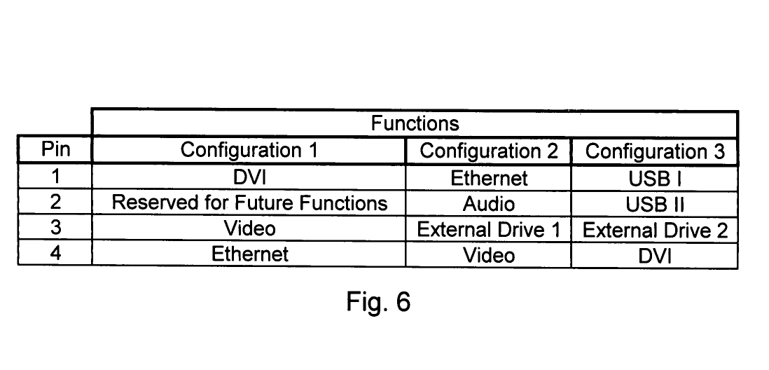

The computing module 10 can communicate with other computer accessories via an interface element, such as a multi-pin connector, which can have a module portion 20, shown in FIGS. 3a and 3b, that mates with a corresponding accessory portion (not shown). The accessory portion can be integral with the accessory or part of a coupling element coupled to the accessory, such as docking station 14 shown in FIG. 1.

Generally, the interface element can have a plurality of individual connection elements. For example, in the illustrated embodiments, the interface element can be a multi-pin connector where the plurality of individual connection elements is a plurality of pin connections. In other implementations, the interface element can be any of various connector types having a plurality of individual connection elements, such as opto-electronic connections, blade type connections, flat surface conductor connections and magnetic communication connections.

The multi-pin connector can be a conventional 160-pin connector that has 160 respective pin connections, i.e., pins in mated engagement with corresponding receptacles. In some implementations, the accessory portion of the connector 20 includes 160 pins, which are each matingly received within respective receptacles, with one exemplary receptacle indicated at 19, formed in the module portion 20 of the connector. In other implementations, the module portion 20 can have 160 pins and the accessory portion can have 160 receptacles to matingly receive the pins. In yet other implementations, the module portion of the connector can have pins and receptacles to mate with receptacles and pins, respectively, of the accessory portion of the connector. It is also recognized that coupling elements other than pins and receptacles could also be used. Further, there may be application where fewer than all pins and/or receptacles are used.

Generally, each pin of the accessory portion of the connector is electrically coupled to one of multiple buses in the accessory, which is in turn electrically connected to one or more functional units of the accessory. Similarly, each receptacle, such as receptacle 19, of the module portion of the connector is electrically connected to one of multiple buses in the module, which is in turn connected to one or more functional units of the module. In this way, when connected via the connector, corresponding functional units of the accessory, such as desktop computer accessory 12 or handheld accessory 16, and a computer module, such as module 10, transmit and/or receive information across the pin connections of the connector 18. Communication between the functional units of the module 10 and accessories facilitate performance of specific computing functions by the accessory, module or both.

As mentioned above, in known systems, a single pin connection of a connector is capable of supporting only a single module or accessory function, or part of such function. For example, a circuit for driving a specific function is located in an accessory and is connected to a single pin connection which is in turn connected to circuitry in the computing module associated with performance of that specific function. In conventional systems, each pin connection is dedicated to supporting the specific function and cannot be reconfigured, including, e.g., reconfiguring the pin connection over time during the life of the equipment.

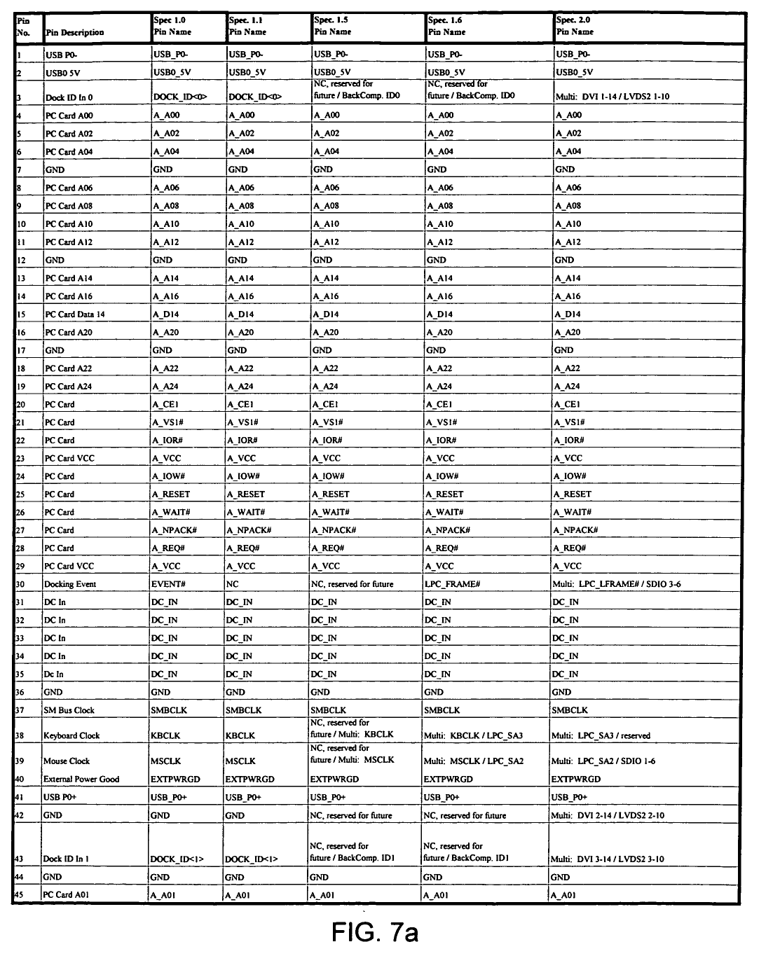

The computing module, connector and computer accessory of the present application, however, provide for the support of multiple functions over a single pin connection. For example, as shown in FIG. 4, pin 26a can support multiple functions, for example F1, F2, and F3, for a computing module 10 and an accessory 30. Each function can be, for example, a USB function, audio function, Ethernet function, or other computing function. Of course, certain functions may require multiple pin connections for performance of that function. Accordingly, for purposes of this disclosure, when referring to a function being supported by a single pin connection, that function can be a necessary subset or part of an overall computing function. For example, a USB computing function may require a 4 pin signal, in which case a single pin connection would support one of the four signals required to run the USB function.

Function specification information regarding which function is to be supported by pin 26a is stored in a function specification memory 32 of the accessory 30. When the module portion 20a and the accessory portion 22a of the connector 18a are connected to establish a connection between the accessory 30 and the computing module 10, the function specification information is caused to be transmitted across a different pin, such as pin 38a, to circuitry, such as BIOS functional enablement logic 34, of the computing module 10 via a bus and bus controller, or bus signal generator, 36.

In certain implementations, the function specification memory 32 can be an EEPROM memory. Also, in certain implementations using the BIOS functional enablement logic 34, the bus can be configured to conform to a specific standard, such as the SMbus (system management bus) standard developed by INTEL, Inc. Generally, an SMbus can be described as a low-level bus, which can facilitate access of the function specification information from the accessory early on in the operating system boot sequence of the module. This allows pin connections to be promptly configured after mating the module to the accessory such that a user interface, such as a touch screen or keyboard, can be turned on for a user to login or adjust settings, prior to completing the operating system boot sequence.

In some embodiments, the BIOS functional enablement logic can be replaced by an application specific integrated circuit (ASIC) and the bus can be one of various information buses, such as a PCI bus, a PCI Express bus, a digital sequence, e.g., an array of pin signals, or an analog signal, such as an analog wave form. The ASIC can be configured to extract the information transmitted via these buses and correspondingly transmit multiplexing signals to the functional enablement circuits as described above. Each type of information bus can have a specific bus transmission capacity for transmitting data. The higher the transmission capacity, the more data the information bus is able to transmit, which results in a higher degree of specificity in configuring the dynamic interface. In specific implementations, the bus controller and function specification memory can be combined into a single device, such as a programmable microcontroller with a memory or some other reconfigurable device.

Depending on the function to be supported as designated by the function specification information, with the functional enablement circuits turned off by default, i.e., automatically turned off when the module is not connected to an accessory, the BIOS functional enablement logic 34 then sends a signal to turn on a functional enablement circuit corresponding to the function to be supported and coupled to a function base circuit. For example, functional enablement circuits 40, 42, 44, and function base circuits 46, 48, 50, correspond to functions F2, F1, and F3, respectively. When turned on, a functional enablement circuit allows information from a function base circuit, which drives the function, corresponding to the function to be supported to be passed to a pin connection, such as pin connection 26a, via a pin bus, such as pin bus 52.

In FIG. 4, function F2 has been designated by the function specification memory to be supported by pin 26a. Accordingly, upon receiving function specification information from the accessory when the accessory and module are properly connected, the BIOS functional enablement logic 34 in the module 10 causes the function enablement circuit 40 for function F2 to turn on. With the function enablement circuit 40 turned on, information from the function base circuit 46 for function F2 is allowed to be transmitted via pin bus 52, across pin connection 26a to a bus of the accessory 30, which is connected to circuitry 54 for performing function F2 in the accessory.

Although not explicitly shown, in some embodiments, accessory 30 could be replaced by an upgraded accessory or a new accessory that designates function F1, which is a different function than the function F2 supported by pin 26a in the current accessory, to be supported by pin 26a. In these embodiments, the BIOS functional enablement logic 34 turns off functional enablement circuits 40, 44 and turns on the functional enablement circuit 42 to allow information from the function base circuit 48 for driving function F1 in the upgraded or new accessory to be transmitted across pin connection 26a.

In other embodiments, function F3 could be designated by the accessory to be supported by pin 26a. In yet other embodiments, the computing module could be capable of selectively driving other functions over a single pin connection in addition to the three supported functions shown in FIG. 4.

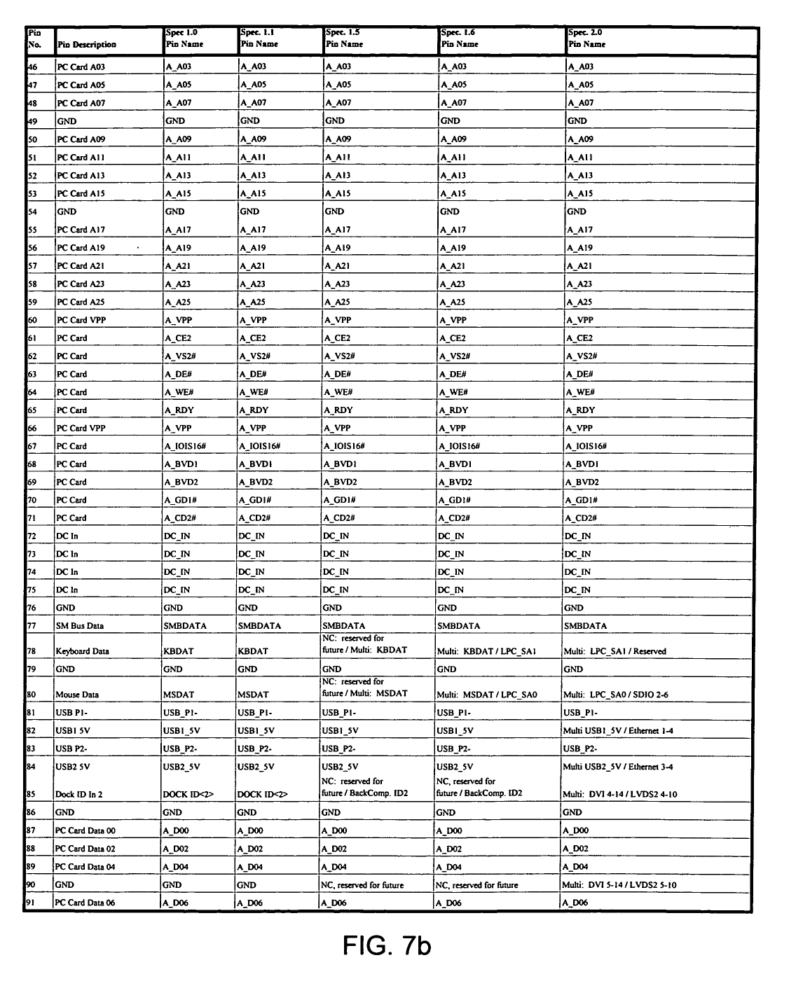

Referring now to FIG. 5, in one embodiment, pin 26b can support multiple functions for a computing module 100 and an accessory 102. Similar to the accessory 30 of FIG. 4, computing module 100 includes a function specification memory 104 that stores function specification information that designates which function is to be supported by pin connection 26b of connector 18b. Generally, the function to be supported by the pin connection is the function driven by the function base circuit in the module and connected to the pin connection. In the illustrated embodiment, the function base circuit 108 connected to pin 26b drives function F2. When the module portion 20b and the accessory portion 22b of the connector 18b are connected, the function specification information designating function F2 is transmitted via bus controller, or bus signal generator, 56 and associated bus in the computing module 100, across pin 38b or the connector 18b, to an intelligent functional enablement logic 106 in the accessory 102. In some embodiments, the intelligent functional enablement logic 106 can be an ASIC, gate array, BIOS chip or any other logic engine capable of interfacing with an intelligent bus.

In certain implementations, the bus associated with bus controller 56 can be configured to conform to a specific standard, such as the COMM (common) bus or SM (system management) bus standard developed by INTEL, Inc.

The accessory 102 includes multiple function circuitry for performing a specific function in the accessory, such as function circuitry 110, 112, 114 for performing functions F1, F2, F3, respectively. Each function circuitry 110, 112, 114 is connected to function enablement circuits 116, 118, 120, respectively, which are each connected to pin bus 122 and thus pin connection 26b. As with the function enablement circuits of the computing module 10 of FIG. 4, the function enablement circuits 116, 118, 120 are turned off by default in this embodiment.

Upon receiving function specification information from the computing module 100, the intelligent functional enablement logic 106 turns on the function enablement circuit for the function to be supported, in this case function enablement circuit 118 for supporting function F2. This allows a direct line of communication from the function base circuit 108 for driving function F2 in the module 100 to the function circuitry 112 for performing function F2 in the accessory 102 via the pin connection 26b.

In some embodiments, an upgraded or new module can replace module 100. The upgraded or new module can have a function base circuit connected to pin connection 26b for driving function F1. When connected, the function specification memory transmits information designating function F1 to be supported by pin connection 26b to the intelligent functional enablement logic 106, which turns on the function enablement circuit 116 corresponding to the circuitry 110 for performing function F1. Information from the functional base circuit for driving function F1 is thus allowed to be transmitted via pin connection 26a to the circuitry 110 such that function F1 can be performed in the accessory 102.

In other embodiments, an upgraded or new module having a function base circuit for driving function F3 that is connected to pin connection 36a can be connected to the accessory 102. The intelligent functional enablement logic 106 can then be instructed to turn on function enablement circuit 120 corresponding to circuitry 114 such that function F3 can be performed in the accessory 102. In yet other embodiments, the function base circuit can drive even more functions and the accessory can have selectively operable circuitry for performing these functions.

The connectors 18a, 18b of FIGS. 4 and 5 can have power interface pin connections 58a, 58b, respectively, designated to connect a power bus of the module and a power bus of the accessory. Alternatively, or in combination with the pin connections 58a, 58b, in some implementations, power from an external power source can be connected to the accessory or module by a connection separate from the connectors 18a, 18b.

Although module 10 of FIG. 4 is illustrated and described as a separate module having certain components and functionality different from module 100 of FIG. 5, it is recognized that the components included in and the functionality described for module 10 and module 100 can be implemented in a single module. Similarly, the components included in and the functionality described for accessory 30 and accessory 102 shown in FIGS. 4 and 5, respectively, can be implemented in a single accessory. Furthermore, a module having the components and functionality of both module 10 and module 100 can be connected to an accessory having the components and functionality of accessory 30 and accessory 102. In such an implementation, each connection element, e.g., pin connection, of the interface between the module and the accessory can support bidirectional flow of communication signals between the module and the accessory. For example, a single pin connection can support a communication signal transmitted from the module to the accessory, such as indicated by the directional arrow associated with pin connection 38a of FIG. 4, and from the accessory to the module, such as indicated by the directional arrow associated with pin connection 38b.

The computing module of the present application can be configured for use in harsh environments or rugged, high-impact, and high-mobility applications. For example, the computing module can include shock- or vibration-absorbing characteristics to protect the module, e.g., if the module were dropped or bumped. Such characteristics can include, but are not limited to, various external and internal damping mechanisms, such as gels, foams, elastomers and springs. Further, various components of the computing module can be made from close-tolerance materials, such as machined aircraft aluminum, to promote effective mating of contiguous parts for sealing, or otherwise protecting, the module from harmful environmental elements, such as moisture, dust and other contaminants. For example, the module can be comprised of an external case having two mating portions and housing electrical components. The two mating portions of the case can be closefitting to provide a high-tolerance fit of the case. Such a high-tolerance fit promotes protection of the internal components of the module from harmful environmental elements. In one specific implementation, the closefitting case achieves a high-tolerance fit with or without the use of seals, such as gaskets, o-rings or rings, interposed between mating case components.

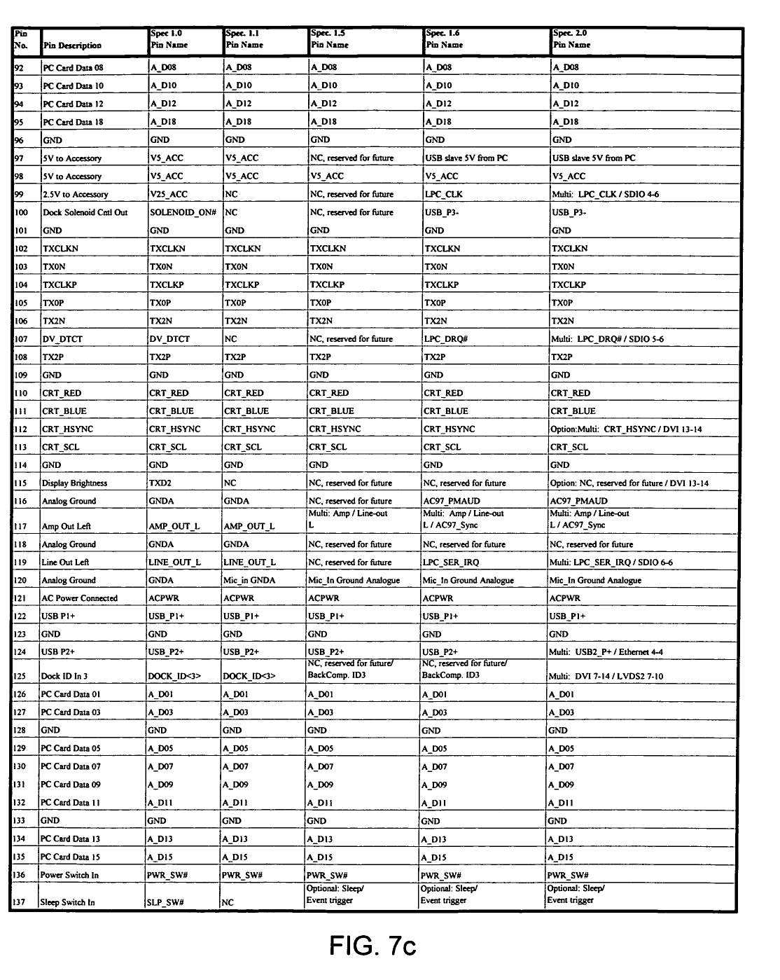

As shown in FIG. 6, the functions or subsets of function that are supported by specific pins are updatable or changeable when different module/accessory configurations are used. For example, Configuration 1 can comprise a computing module connected to a handheld computer accessory. In Configuration 1, for example, pin connection 1 supports one of potentially several transmissions of information required to run a DVI function, pin connection 3 supports one of potentially several transmissions of information required to run a video function and pin connection 4 supports one of potentially several transmissions of information required to run an Ethernet function. Pin connection 2 is reserved for future functions such as if an updated operating system with enhanced functionality is implemented into the handheld computer accessory, at which time, the module can be modified to support additional functionality over pin connection 2.

Configuration 2 can comprise the computing module of Configuration 1 connected to a laptop computer accessory. In operation, the module can be disconnected from the handheld computer accessory of Configuration 1 and connected to the laptop computer accessory to implement Configuration 2. Upon connection to the laptop computer accessory, the pin connections are reconfigured to support at least a part of functions, such as those listed in FIG. 6, that may be different than those supported in Configuration 1. As one example, the part of the Ethernet function supported by pin 4 in Configuration 1 or a different part of the Ethernet function can be supported by pin 1 in Configuration 2.

Similarly, Configuration 3 can comprise the computing module of Configurations 1 and 2 connected to a desktop computer accessory, perhaps via a docking station. The module can be disconnected from the laptop computer accessory of Configuration 2 and connected to the desktop computer accessory to implement Configuration 3. Upon connection to the desktop computer accessory, the pin connections are reconfigured to support at least a part of functions, such as those listed in FIG. 6, that may be different than those supported in Configuration 2.

Of course the same principles apply to switching from any one of Configurations 1-3 to any other of Configurations 1-3 described above in no particular order. Further, as described above, more than three configurations are possible by providing additional accessories to which the module can connect. Other configurations are also possible by updating the hardware, software or firmware of the accessories of Configurations 1-3 such that the functions supported by the pin connections are updated or changed over those shown in FIG. 6.

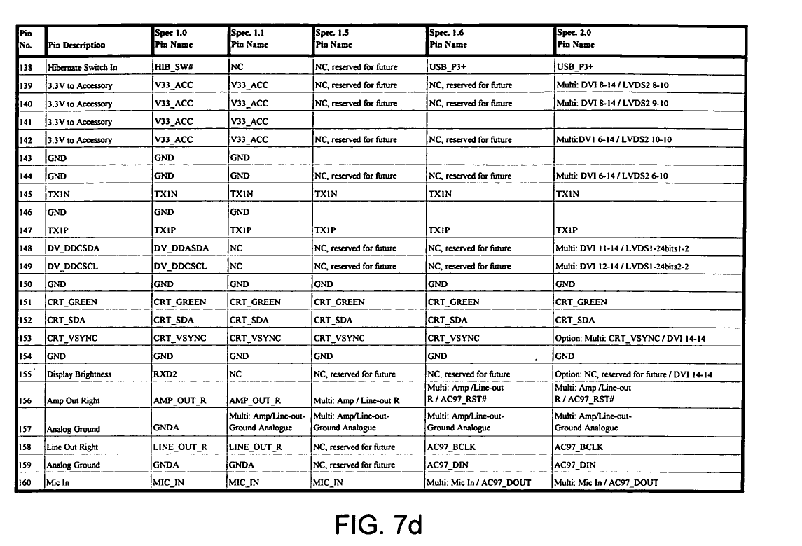

According to several exemplary embodiments, the function or functions supported by each pin connection of a multi-pin connector having 160 respective pin connections are shown in FIGS. 7a-7d.

According to one exemplary embodiment, i.e., Specification 1.0 of FIGS. 7a-7d, each pin connection is assigned a single unique function. For example, pin connection-37 supports function SMBCLK.

According to a similar exemplary embodiment, i.e., Specification 1.1 of FIGS. 7a-7d, some pin connections are assigned a single unique function and some of the pin connections assigned a unique function in Specification 1.0 are not assigned a function. In this embodiment, the pin connections supporting a function support the same function as in Specification 1.0 except for pin connection-120, which now supports function Mic_In GNDA.

According to another exemplary embodiment, i.e., Specification 1.5 of FIGS. 7a-7d, some pin connections are assigned a single unique function, some pin connections are reserved for future functions and some pin connections are assigned or support multiple functions. For example, pin connection-107 supports function LPC_DRQ#, pin connection-138 is reserved for a future function or functions, and pin connection-117 supports functions Amp and Line-out L.

According to another exemplary embodiment, i.e., Specification 1.6 of FIGS. 7a-7d, some pin connections are assigned a single unique function, some pin connections are reserved for future functions and some pin connections are assigned or support multiple functions. For example, pin connection-112 supports function CRT_HSYNC, pin connection-139 is reserved for a future function or functions, and pin connection-156 supports functions Amp, Line-out R and AC97_RST#.

According to yet another exemplary embodiment, i.e., Specification 2.0 of FIGS. 7a-7d, some pin connections are assigned a single unique function, some pin connections are reserved for future functions and some pin connections are assigned or support multiple functions. For example, pin connection-158 supports function AC97_BCLK, pin connection-118 is reserved for a future function or functions, and pin connection-142 supports finctions DVI 10-14 and LVDS2 10-10.

It is recognized that the above embodiments are merely exemplary and that any number of alternative pin and function configurations is possible.

As discussed above, the usable lifetime of an accessory or computing module is lengthened because functional upgrades of either an accessory or a computer module may not inhibit interoperability over time. Users can rely on the long-term interoperability of the accessory/module arrangement with greater assurance since upgrades in the modular computing module or accessories, while increasing system functionality for new applications, will not squander existing investments in systems implementing an accessory/module arrangement. For example, users can selectively upgrade components of the accessory/module arrangement described herein instead of replacing an entire system, as might be required with known single pin/single function arrangements.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer system comprising:
a computer accessory;
a modular computing module having a core processor and a memory; and
a connector configured to detachably and electrically connect the computer accessory and the modular computing module, the connector having a plurality of connecting elements configured to support communication between the modular computing module and the computer accessory;
wherein at least one of the plurality of connecting elements comprises a dynamic connecting element capable of supporting multiple computing functions.

2. The computer system of claim 1, wherein the modular computing module comprises a self-contained, high-tolerance and shock-resistant modular computing module.

3. The computer system of claim 1, wherein the computer accessory comprises a portable computing device.

4. The computer system of claim 1, wherein the computer accessory comprises a stationary computing device.

5. The computer system of claim 1, wherein said dynamic connecting element supports one of the multiple computing functions at a time, and wherein the supported computing function is changeable.

6. The computer system of claim 1, wherein the dynamic connecting element comprises a first connecting element, and wherein there is at least a second connecting element configured to support a transfer of stored function information between the computer accessory and the modular computing module, and wherein the stored function information specifies one of the multiple functions to be supported by the dynamic connecting element.

7. The computer system of claim 6, wherein the bus controller initiates and controls the transfer of the stored function information via an intelligent bus.

8. The computer system of claim 6, wherein the stored function information is stored in a function specification memory.

9. The computer system of claim 1, further comprising a wearable harness, and wherein the accessory and the modular computing module are removably attached to the harness.

10. The computer system of claim 6, wherein the accessory comprises a function specification memory and the module comprises a functional logic element, and wherein the stored function information is transferred between the function specification memory and the functional enablement logic element.

11. The computer system of claim 6, wherein the module comprises a function specification memory and the accessory comprises a functional logic element, and wherein the stored function information is transferred between the function specification memory and the functional enablement logic element.

12. The computer system of claim 1, wherein the modular computing module can support at least two functions, and wherein when the modular computing module is connected to the computer accessory, the computer accessory transmits a signal to the modular computing module to designate the dynamic connecting element to support one of the at least two functions.

13. The computer system of claim 12, wherein the computer accessory comprises a first computing accessory, the system further comprising a second computer accessory detachably connectible to the modular computing module, wherein when the second computer accessory is connected to the modular computing module, the second computer accessory transmits a signal to the modular computing module to designate the dynamic connecting element to support a second of the at least two functions.

14. The computer system of claim 1, wherein the computer accessory can support at least two separate functions, and wherein when the computer accessory is connected to the modular computing module, the modular computing module transmits a signal to the computer accessory to designate the dynamic connecting element to support one of the at least two functions.

15. The computer system of claim 14, wherein the modular computing module comprises a first modular computing module, the system further comprising a second modular computing module detachably connectible to the computer accessory, wherein when the second modular computing module is connected to the computer accessory, the second modular computing module transmits a signal to the computer accessory to designate the dynamic connecting element to support a second of the at least two functions.

16. The computer system of claim 1, further comprising multiple function enablement circuits electrically coupled to the dynamic connecting element, wherein each enablement circuit corresponds to and is capable of enabling one of the multiple functions supported by the connecting element, and wherein when the computer accessory and the modular computing module are connected, the function enablement circuit corresponding to a desired one of the multiple functions to be supported by the dynamic connecting element is activated and the other circuits are deactivated.

17. The computer system of claim 1, wherein multiple ones of the plurality of connecting elements are dynamic connecting elements each capable of supporting multiple functions.

18. The computer system of claim 1, wherein the connector comprises a first portion connected to the modular computing module and a second portion coupled to the computer accessory, wherein the first portion and the second portion matingly engage each other to couple to the computer accessory and the modular computing module.

19. The computer system of claim 18, wherein the second portion comprises a docking station.

20. The computer system of claim 1, wherein the computer accessory comprises one or more desktop computers, one or more handheld computing devices, one or more portable computers, one or more multiple function machine chassis or a combination thereof.

21. The computer system of claim 1, wherein communication between the modular computing module and the computer accessory is transmitted via an information bus.

22. The computer system of claim 1, wherein the dynamic connecting element is configured to support an electrical power link between the computer accessory and the modular computing module.

23. The computer system of claim 1, wherein the connector comprises a multi-pin connector and the connecting elements comprise pin connections.

24. A method of interfacing a modular computer module and a computer accessory, comprising:
detachably connecting a modular computer module having a core processor and a memory with a computer accessory via a connector having a plurality of connecting elements, wherein at least a first connecting element is capable of supporting multiple computing functions;
transmitting a first stored function specification signal from a memory in the module to a function enablement logic element in the accessory or from a memory in the accessory to a function enablement logic element in the module via a second connecting element, the first stored function specification signal specifying a first desired function to be supported by the first connecting element;
sending a signal from the enablement logic in the accessory to activate a first of multiple function enablement circuits in the accessory or from the enablement logic in the module to activate a first of multiple function enablement circuits in the module, wherein the first of the multiple function enablement circuits are coupled to the first connecting element and correspond to the first desired function; and
supporting the first desired function via the first connecting element.

25. The method of claim 24, further comprising:
transmitting a second stored function specification signal from the memory in the module to the function enablement logic in the accessory or from the memory in the accessory to the function enablement logic in the module via the second connecting element, the second stored function specification signal specifying a second desired function to be supported by the first connecting element;
sending a signal from the enablement logic in the accessory to activate a second of the multiple function enablement circuits in the accessory or from the enablement logic in the module to activate a second of the multiple function enablement circuits in the module, wherein the second of the multiple function enablement circuits are coupled to the first pin connecting element and correspond to the second desired function, and wherein one of the first multiple function enablement circuits is caused to be deactivated;
supporting the second desired function via the first connecting element.

26. The method of claim 24, wherein the modular computing module comprises a first modular computing module and the computer accessory comprises a first computer accessory, the method further comprising:
disconnecting the first modular computing module from the first computer accessory and detachably connecting a second modular computing module to the first computer accessory via the connector;
transmitting a second stored function specification signal from a memory in the second module to the function enablement logic in the accessory or from the memory in the accessory to a function enablement logic in the second module via the second connecting element, the second stored function specification signal specifying a second desired function to be supported by the first connecting element;
sending a signal from the enablement logic in the first accessory to activate a second of multiple function enablement circuits in the first accessory or from the enablement logic in the second module to activate a second of multiple function enablement circuits in the second module, wherein the second of multiple function enablement circuits correspond to the second desired function, and wherein one of the first multiple function enablement circuits is caused to be deactivated; and
supporting the second desired function via the first connecting element.

27. The method of claim 24, wherein the modular computing module comprises a first modular computing module and the computer accessory comprises a first computer accessory, the method further comprising:
disconnecting the first computer accessory from the first modular computing module and detachably connecting a second computer accessory to the first modular computing module via the connector;
transmitting a second stored function specification signal from the memory in the first module to a function enablement logic in the second accessory or from a memory in the second accessory to the function enablement logic in the first module via the second connecting element, the second stored function specification signal specifying a second desired function to be supported by the first connecting element;
sending a signal from the enablement logic of the second accessory to activate a second of multiple function enablement circuits in the second accessory or from the enablement logic of the first module to activate a second of multiple function enablement circuits in the first module, wherein the second of multiple function enablement circuits correspond to the second desired function, and wherein one of the first multiple function enablement circuits is caused to be deactivated; and
supporting the second desired function via the first connecting element.

28. The method of claim 24, wherein transmitting the first stored function specification signal comprises controlling transmission of the first stored function specification signal from the memory in the module to the function enablement logic element in the accessory with a bus controller in the module or from the memory in the accessory to the function enablement logic element in the module with a bus controller in the accessory.

29. A method of interfacing a modular computer module and a computer accessory, comprising:
detachably connecting a modular computer module having a core processor and a memory with a computer accessory via a connector having a plurality of connecting elements, wherein at least a first connecting element is capable of supporting a first function, a second function and a third function;
transmitting a first stored function specification signal specifying the first function to be supported by the first connecting element;
activating a first function enablement circuit coupled to the first connecting element to allow the first connecting element to support the first function;
transmitting a second stored function specification signal specifying the second function to be supported by the first connecting element;
deactivating the first function enablement circuit;
activating a second function enablement circuit coupled to the first connecting element to allow the first connecting element to support the second function;
transmitting a third stored function specification signal specifying the third function to be supported by the first connecting element;
deactivating the second function enablement circuit;
activating a third function enablement circuit coupled to the first connecting element to allow the first connecting element to support the third function.

30. A data processing system, comprising:
a computer accessory;
a modular computing core having a processor and a memory and configured to detachably and electrically connect to the computer accessory; and
means for establishing a dynamic multiplexing interface between the computer accessory and the modular computing core, the interface having multiple connecting elements;
wherein at least one connecting element of the dynamic multiplexing interface supports multiple computing functions.

31. A dynamic interface between a modular computing module and a computer accessory, comprising:
at least a first connecting element capable of supporting multiple computing functions; and
at least a second connecting element capable of supporting a function specification transmission generated from a dedicated function specification memory in either the module or the computer accessory, the information transmission specifying one of the multiple computing functions to be supported by the first connecting element.

32. The dynamic interface of claim 31, wherein the first connecting element comprises a first pin connection and the second connecting element comprises a second pin connection.

33. The dynamic interface of claim 31, wherein the dynamic interface includes the 160 connection elements as designated in FIGS. 7a, 7b, 7c, 7d, and wherein the first connecting element and the second connecting element are two of the 160 connecting elements.
